(19) United States
(12) Patent Application Publication
(10) Pub. No.: US 2026/0317105 A1
(43) Pub. Date: Oct. 15, 2026

(54) APPARATUS FOR SUPPLYING SEPARATOR OF SECONDARY BATTERY

(71) Applicant: HANA TECHNOLOGY CO., LTD., Yongin-si, Gyeonggi-do (KR)

(72) Inventor: Gi Bong CHO, Yongin-si, Gyeonggi-do (KR)

(21) Appl. No.: 18/994,186

(22) PCT Filed: Nov. 18, 2024
(86) PCT No.: PCT/KR2024/096605

§ 371 Date: Jan. 14, 2025

(30) Foreign Application Priority Data
Dec. 14, 2023 (KR) 10-2023-0181789

(51) Int. Cl. B65H 23/04; B65H 20/32

(52) U.S. Cl. CPC B65H 23/044; B65H 20/32; B65H 2406/311; B65H 2553/40; B65H 2801/72

(57) ABSTRACT

Proposed is an apparatus for supplying secondary battery separators, which prevents tension applied to a separator from rapidly increasing even in situations where a sudden change occurs in the separator's transfer speed by controlling the tension applied to the side of the separator located in the internal space of a body part using only pressure generated by the flow of air flowing from an intake to an outlet.

### TECHNICAL FIELD

The present disclosure relates to an apparatus for supplying secondary battery separators and, more particularly, to an apparatus for supplying secondary battery separators, which prevents tension applied to a separator from rapidly increasing even in situations where a sudden change occurs in the separator's transfer speed by controlling the tension applied to the side of the separator located in the internal space of a body part using only pressure generated by the flow of air flowing from an intake to an outlet.

### BACKGROUND ART

Recently, as the development of electric vehicles, energy storage batteries, robots, and satellites has begun in earnest, research on secondary batteries, which are high-performance batteries that can be charged and discharged repeatedly, is actively underway. Commercialized secondary batteries at present include nickel-cadmium batteries, nickel-hydrogen batteries, nickel-zinc batteries, and lithium-ion secondary batteries. Among these, lithium-ion secondary batteries are in the spotlight due to their advantages of having a very low self-discharge rate and higher energy density, and being safe to partially charge and discharge as there is almost no memory effect compared to nickel-based secondary batteries.

A secondary battery is composed of a positive electrode plate, a separator (membrane), and a negative electrode plate sequentially stacked and immersed in an electrolyte. The stacking method for fabricating a cell stack inside a secondary battery is largely divided into two types. The first is winding a negative electrode plate, a separator, a positive electrode plate, and a separator in that order continuously to form a jelly-roll. The second is alternately stacking a negative electrode plate, a separator, a positive electrode plate, and a separator after cutting the negative and positive electrode plates to the required size. As the stacking method is advantageous in terms of the lifespan and space efficiency of secondary batteries in producing high-capacity or large-sized secondary batteries, the number of cases of its adoption for electric vehicles is increasing.

To perform a stacking process, a separator needs to be put into a stacking device that performs the stacking process. When inserting such a separator, it is common to use a dancer roll to control tension, details of which are explained below.

FIG. 1 is a reference view showing a tension control system equipped with a conventional dancer roll.

Below, the structure and resulting problems of a tension control system equipped with a dancer roll will be briefly described with reference to the attached drawings.

Referring to FIG. 1, a conventional tension control system 9 includes a dancer roll 910 that applies a constant tension to a workpiece P. In addition, a lever (not shown) is coupled to the end of the dancer roll 910. The dancer roll 910 is configured to rotate based on the rotation center point of a link due to the displacement of a pneumatic cylinder (not shown). In addition, the pneumatic cylinder cannot be considered an active tension feedback control system because it operates by maintaining a constant pressure that is manually set in a connected valve. Rather, the pneumatic cylinder mainly functions as a tension damper to absorb changes in tension occurring in a span.

The conventional tension control system 9 may include a first roll 920 that advances the workpiece P, a first electric motor 930 that transmits force to the first roll 920, a first inverter 940 that drives the first electric motor 930, a transducer 950 that converts a position change of the dancer roll 910 into an electrical signal, a fixed roll 960 that movably supports the workpiece P to which a certain tension is applied by the dancer roll 910, a second roll 970 that advances the workpiece P, a second electric motor 980 that transmits force to the second roll 970, and a second inverter 990 receives position information of the dancer roll 910 and drives the second electric motor 980.

To describe the operation method of the conventional system 9, first, the first electric motor 930 is actuated by the first inverter 940, and the second electric motor 980 is actuated by the second inverter 990. At this time, the dancer roll 910 is in a transient state for an initial certain period of time and swings significantly left and right and/or up and down. This also applies when the feed speed of the workpiece P changes rapidly.

At this time, the position signal of the dancer roll 910 is converted into an electrical signal and routed to the second inverter 990, and the second inverter 990 controls the speed of the second electric motor 980 by outputting a frequency that compensates for the difference between the preset position value of the dancer roll 910 and the position value of the returned dancer roll 910. Due to this, the dancer roll 910 stays at a center point that is not biased left or right or up and down, thereby transmitting uniform tension to the workpiece 910.

In this structure, when the feed speed of the workpiece P changes rapidly, the inertia of the dancer roll 910 and the lever makes the immediate movement of the dancer roll 910 impossible, which may cause a problem in which the tension applied to the workpiece P suddenly rapidly increases.

In order to solve the above-mentioned problems, the inventor of the present disclosure proposes a new apparatus for supplying secondary battery separators with improved structure/function, details of which will be described later.

### Documents of Related Art

(Patent Document 1) Korean Patent No. 10-0662755 “METHOD FOR CONTROLLING OPERATION OF TENSION-CONTROLLING SYSTEM HAVING DANCER ROLL”

### DISCLOSURE

### Technical Problem

Accordingly, the present disclosure has been made keeping in mind the above problems occurring in the related art, and an objective of the present disclosure is to provide an apparatus for supplying secondary battery separators, which prevents tension applied to a separator from rapidly increasing due to the inertia of mechanical parts such as a roller even in situations where a sudden change occurs in the separator's transfer speed by controlling the tension applied to the side of the separator located in the internal space of a body part using only pressure generated by the flow of air flowing from an intake to an outlet.

In addition, an objective of the present disclosure is to provide an apparatus for supplying secondary battery separators, which allows a predetermined level of tension to be applied to a separator by the operation of a vacuum pump coupled with an outlet, allowing the tension applied to the separator to be controlled by means of pneumatic pressure rather than mechanical control.

In addition, an objective of the present disclosure is to provide an apparatus for supplying secondary battery separators, which enables accurate location identification of a separator by providing a detection part that detects the position of the separator located in the internal space of a body part.

In addition, an objective of the present disclosure is to provide an apparatus for supplying secondary battery separators, which enables precise detection of a separator by having a detection part include a transmission-type photosensor.

In addition, an objective of the present disclosure is to provide an apparatus for supplying secondary battery separators, which ensures that a separator is accurately placed in the reference position at the standby time of a stacking device by providing a home sensor between a first limit sensor and a second limit sensor.

In addition, an objective of the present disclosure is to provide an apparatus for supplying secondary battery separators, which prevents a separator from sticking to the interior wall of first and/or second surfaces of a body part by providing an adsorption prevention part on the first and/or second surfaces of the body part.

In addition, an objective of the present disclosure is to provide an apparatus for supplying secondary battery separators, which controls the effective gap between a spacer and an adjacent separator end to prevent damage while maintaining the pressure applied to the separator at a desired level by providing the spacer on the internal space side of a body part.

In addition, an objective of the present disclosure is to provide an apparatus for supplying secondary battery separators, which ensures smooth stacking by providing a first operation control module that stops the operation of a stacking device or slows down the operation speed when a first limit sensor does not detect a separator located in the internal space of a body part.

In addition, an objective of the present disclosure is to provide an apparatus for supplying secondary battery separators, which ensures smooth stacking by providing a second operation control module that stops the operation of a feeding part or slows down the feeding speed when a second limit sensor detects a separator located in the internal space of a body part.

In addition, an objective of the present disclosure is to provide an apparatus for supplying secondary battery separators, which prevents a first operation control module and/or a second operation control module from operating immediately after a stacking device is driven by providing a third operation control module that stops the operation of a feeding part when a home sensor detects a separator at the standby time of the stacking device.

### Technical Solution

In order to achieve the above objectives, the present disclosure may be implemented by embodiments having the following configuration.

According to an embodiment of the present disclosure, an apparatus for supplying secondary battery separators according to the present disclosure includes: a pair of roller parts spaced apart from each other on a side adjacent to a tension adjustment part; the tension adjustment part configured to control a tension applied to a separator put into an internal space thereof through pneumatic control; and a control part configured to control an operation of the tension adjustment part.

According to another embodiment of the present disclosure, in the apparatus for supplying secondary battery separators according to the present disclosure, the tension adjustment part may include: a body part constituting a body of the tension adjustment part and having the internal space for putting into a separator; an intake configured to be formed open in the body part to allow a separator to be put into the internal space of the body part; and an outlet configured to communicate with the internal space of the body part and allow air from the internal space of the body part to be sucked in and discharged.

According to still another embodiment of the present disclosure, in the apparatus for supplying secondary battery separators according to the present disclosure, the outlet may be connected to a vacuum pump so that air flows from the intake and is discharged when the vacuum pump operates.

According to still another embodiment of the present disclosure, in the apparatus for supplying secondary battery separators according to the present disclosure, the tension adjustment part may further include a detection part disposed on a side of the body part to detect a position of a separator put into the internal space of the body part.

According to still another embodiment of the present disclosure, in the apparatus for supplying secondary battery separators according to the present disclosure, the detection part may include: a first limit sensor provided on a side adjacent to the intake and configured to detect a separator in the internal space of the body part; and a second limit sensor spaced apart from the first limit sensor on a side adjacent to the outlet and configured to detect a separator in the internal space of the body part.

According to still another embodiment of the present disclosure, in the apparatus for supplying secondary battery separators according to the present disclosure, the detection part may further include a home sensor provided between the first limit sensor and the second limit sensor and configured to detect a separator in the internal space of the body part.

According to still another embodiment of the present disclosure, in the apparatus for supplying secondary battery separators according to the present disclosure, the home sensor may be located at a random position between the adjacent first and second limit sensors.

According to still another embodiment of the present disclosure, in the apparatus for supplying secondary battery separators according to the present disclosure, the detection part may be composed of a photosensor.

According to still another embodiment of the present disclosure, in the apparatus for supplying secondary battery separators according to the present disclosure, the tension adjustment part may further include an adsorption prevention part coupled to first and/or second surfaces of the body part and configured to inject gas into the internal space of the body part.

According to still another embodiment of the present disclosure, in the apparatus for supplying secondary battery separators according to the present disclosure, the tension adjustment part may further include a spacer provided on a side of front and/or rear surfaces or on a side adjacent to the front and/or rear surfaces of the body part in the internal space of the body part, and configured to set the size of a gap between an interior wall of the front and/or rear surfaces of the body part and an adjacent separator end.

According to still another embodiment of the present disclosure, the apparatus for supplying secondary battery separators according to the present disclosure may further include: a feeding part configured to supply separators to the tension adjustment part; and a stacking device configured to perform a stacking operation using separators supplied from the roller parts and the tension adjustment part, and the control part may include a first operation control module configured to stop an operation of the stacking device or slow down an operation speed when the first limit sensor does not detect a separator located in the internal space of the body part.

According to still another embodiment of the present disclosure, in the apparatus for supplying secondary battery separators according to the present disclosure, the control part may further include a second operation control module configured to stop an operation of the feeding part or slow down a feeding speed when the second limit sensor detects a separator located in the internal space of the body part.

According to still another embodiment of the present disclosure, the apparatus for supplying secondary battery separators according to the present disclosure may further include: a feeding part configured to supply separators to the tension adjustment part; and a stacking device configured to perform a stacking operation using separators supplied from the roller parts and the tension adjustment part, and the control part may further include a third operation control module configured to stop an operation of the feeding part when the home sensor detects a separator at a standby time of the stacking device.

### Advantageous Effects

The present disclosure has the following effects by the above-described configuration.

According to the present disclosure, it is possible to prevent tension applied to a separator from rapidly increasing due to the inertia of mechanical parts such as a roller even in situations where a sudden change occurs in the separator's transfer speed by controlling the tension applied to the side of the separator located in the internal space of a body part using only pressure generated by the flow of air flowing from an intake to an outlet.

Furthermore, according to the present disclosure, by allowing a predetermined level of tension to be applied to a separator by the operation of a vacuum pump coupled with an outlet, it is possible to control the tension applied to the separator by means of pneumatic pressure rather than mechanical control.

Furthermore, according to the present disclosure, an accurate location identification of a separator is possible by providing a detection part that detects the position of the separator located in the internal space of a body part.

Furthermore, according to the present disclosure, precise detection of a separator is possible by having a detection part include a transmission-type photosensor.

Furthermore, according to the present disclosure, by providing a home sensor between a first limit sensor and a second limit sensor, it is possible to ensure that a separator is accurately placed in the reference position at the standby time of a stacking device.

Furthermore, according to the present disclosure, by providing an adsorption prevention part on first and/or second surfaces of a body part, it is possible to prevent a separator from sticking to the interior wall of the first and/or second surfaces of the body part.

Furthermore, according to the present disclosure, by providing a spacer on the internal space side of a body part, the effective gap between the spacer and an adjacent separator end can be controlled to prevent damage while maintaining the pressure applied to the separator at a desired level.

Furthermore, according to the present disclosure, smooth stacking can be ensured by providing a first operation control module that stops the operation of a stacking device or slows down the operation speed when a first limit sensor does not detect a separator located in the internal space of a body part.

Furthermore, according to the present disclosure, smooth stacking can be ensured by providing a second operation control module that stops the operation of a feeding part or slows down the feeding speed when a second limit sensor detects a separator located in the internal space of a body part.

Furthermore, according to the present disclosure, by providing a third operation control module that stops the operation of a feeding part when a home sensor detects a separator at the standby time of a stacking device, it is possible to prevent a first operation control module and/or a second operation control module from operating immediately after the stacking device is driven.

Meanwhile, it should be added that even if effects are not explicitly mentioned herein, the effects described in the following specification expected by the technical features of the present disclosure and their potential effects are treated as if they were described in the specification of the present disclosure.

### DESCRIPTION OF DRAWINGS

FIG. 1 is a reference view showing a tension control system equipped with a conventional dancer roll;

FIG. 2 is a perspective view showing an apparatus for supplying secondary battery separators according to an embodiment of the present disclosure;

FIG. 3 is a front view showing the apparatus for supplying secondary battery separators according to FIG. 2;

FIG. 4 is a vertical cross-sectional view showing the apparatus for supplying secondary battery separators according to FIG. 2;

FIG. 5 is a reference view showing the internal space of a body part according to FIG. 2;

FIGS. 6 to 8 are reference vertical cross-sectional views showing the operation of a detection part and a control part;

FIG. 9 is a reference view showing a spacer according to FIG. 2; and

FIG. 10 is a block view of a control part according to FIG. 2.

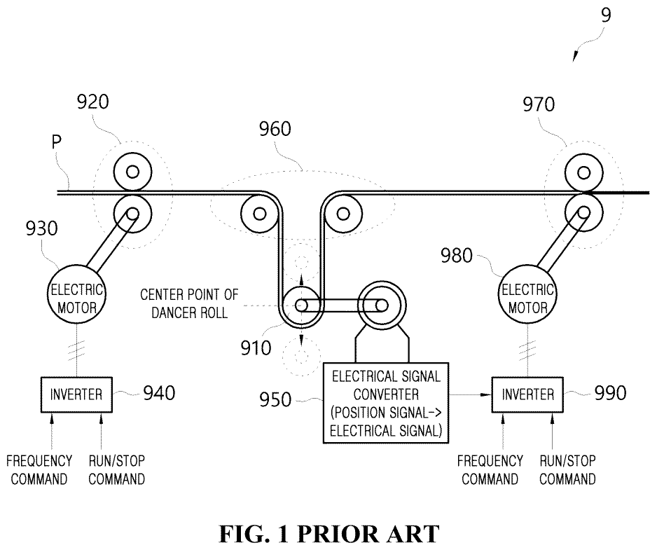

### MODE FOR INVENTION

Hereinafter, embodiments of the present disclosure will be described in more detail with reference to the accompanying drawings. The embodiments of the present disclosure may be modified in various forms, and the scope of the present disclosure should not be construed as being limited to the following embodiments, but should be construed based on the matters described in the claims. In addition, these embodiments are only provided for reference in order to more completely explain the present disclosure to those of ordinary skill in the art.

As used herein, the singular form may include the plural form unless the context clearly indicates otherwise. In addition, as used herein, “comprise” and/or “comprising” specify the presence of the recited shapes, numbers, steps, operations, members, elements, and/or groups thereof, but do not exclude the presence or addition of one or more other shapes, numbers, steps, operations, members, elements, and/or groups thereof.

Hereinafter, it should be noted that when one component (or layer) is described as being disposed on another component (or layer), one component may be disposed directly on another component, or another component(s) or layer(s) may be located between the components. In addition, when one component is expressed as being directly disposed on or above another component, no other component(s) are located between the components. Moreover, being located on “top”, “upper”, “lower”, “top”, “bottom” or “one (first) side” or “side” of a component means a relative positional relationship.

Hereinafter, the explanation that one component and another component are “connected” or “coupled” should be understood as a concept that includes not only the direct connection or combination of both components, but also the indirect connection or combination by another component.

Additionally, it should be noted that in the following, when describing the components, although numbers are written in front of the components such as “first”, “second”, etc., this is an arbitrary configuration, and the second configuration does not presuppose the first configuration, but is independent of each other.

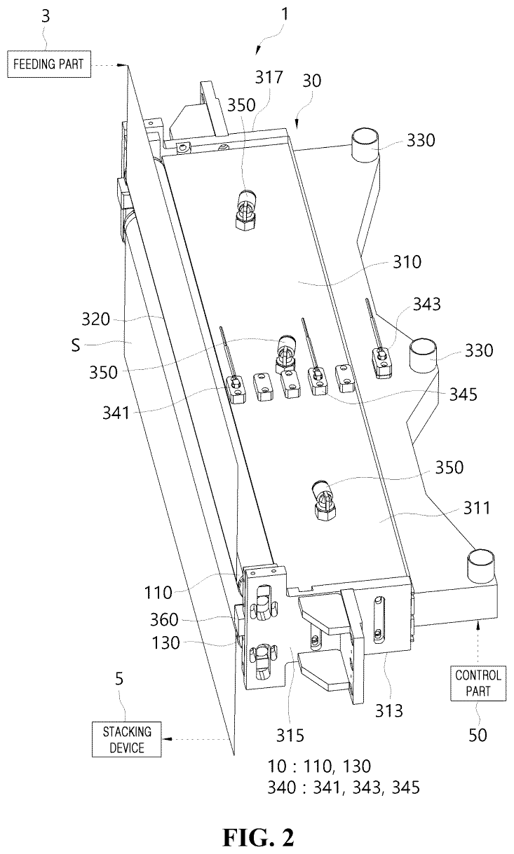

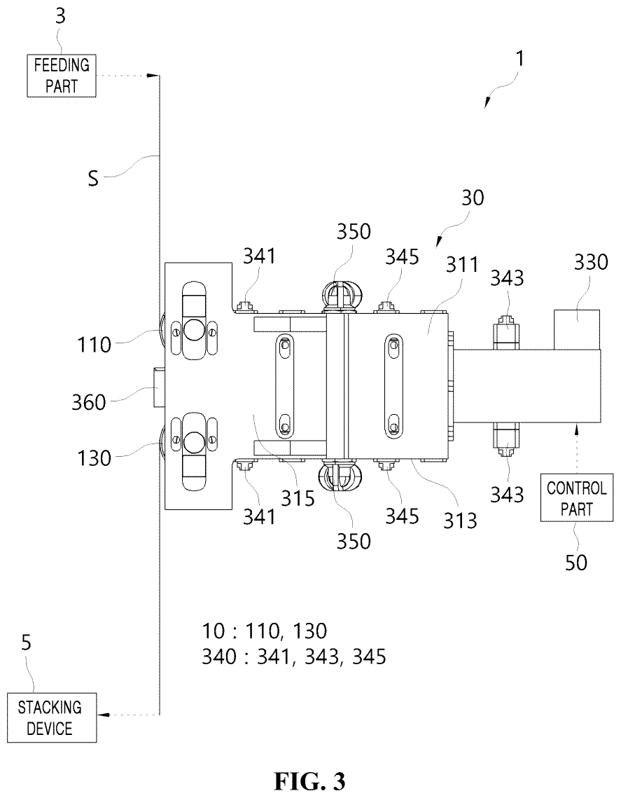

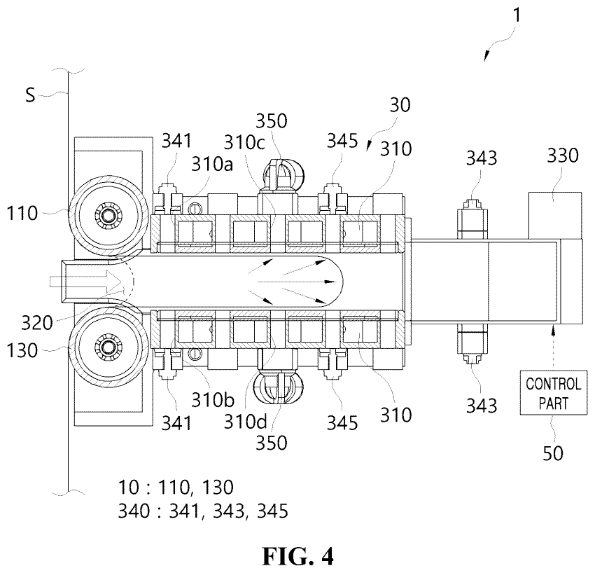

FIG. 2 is a perspective view showing an apparatus for supplying secondary battery separators according to an embodiment of the present disclosure; FIG. 3 is a front view showing the apparatus for supplying secondary battery separators according to FIG. 2; and FIG. 4 is a vertical cross-sectional view showing the apparatus for supplying secondary battery separators according to FIG. 2.

Hereinafter, an apparatus 1 for supplying secondary battery separators (hereinafter referred to as “separator”; S) according to an embodiment of the present disclosure will be described in detail with reference to the attached drawings.

Referring to FIGS. 2 to 4, the present disclosure relates to the apparatus 1 for supplying secondary battery separators and, more particularly, to an apparatus 1 for supplying secondary battery separators, which prevents tension applied to a separator S from rapidly increasing even in situations where a sudden change occurs in the separator's transfer speed by controlling the tension applied to the side of the separator S located in the internal space of a body part 310 using only pressure generated by the flow of air flowing from an intake 320 to an outlet 330.

The above apparatus 1 for supplying secondary battery separators may be, for example, provided between a feeding part 3, which supplies separators S to the apparatus 1, and a stacking device 5, which receives separators S that have passed through the apparatus 1, but it should be noted that the scope of the present disclosure is not limited thereto. As an example, the apparatus 1 for supplying secondary battery separators according to an embodiment of the present disclosure may be used in devices other than the stacking device. The above-described feeding part 3 is, for example, a pair of rollers that supplies a separator, and the stacking device 5 may be a device that alternately stacks, for example, a negative electrode plate, a separator, a positive plate, and a separator.

The apparatus 1 for supplying secondary battery separators according to an embodiment of the present disclosure may include a roller part 10, a tension adjustment part 30, and a control part 50.

The roller part 10 is a roller configuration provided on one side of the tension adjustment part 30. The roller part 10 may be provided, for example, on a side adjacent to the intake 320, which is the entrance side of the tension adjustment part 30. Additionally, the roller part 10 may have a first roller 110 and a second roller 130 spaced apart from each other. At this time, the first roller 110 and the second roller 130 are idle rollers, and are spaced apart from each other along the vertical direction in the drawing, but may be spaced apart along the front-back or left-right direction depending on the arrangement of the tension adjustment part 30, and there is no particular limitation thereon. It is preferable that the first roller 110 and the second roller 130 are provided in a position so as not to overlap the intake 320. For example, opposite end sides of the first roller 110 and the second roller 130 facing each other may be formed so as not to block the intake 320.

In addition, as an example, the first roller 110 and the second roller 130 may be formed of aluminum (Al). For example, the first roller 110 may allow one side of a separator S supplied through the feeding part 3 to be put into the internal space of the tension adjustment part 30 (or the internal space of the body part 310), and the second roller 130 may allow the separator S connected from the internal space of the tension adjustment part 30 and exposed to the outside to be put into the stacking device 5.

The tension adjustment part 30 is provided on the side adjacent to the roller part 10 and allows a separator S to be put into the internal space thereof to control the tension applied to the separator S located between the rollers 110 and 130. At this time, the internal space of the tension adjustment part 30 is preferably located on a side that overlaps the separation space between the first roller 110 and the second roller 130.

To this end, the tension adjustment part 30 may include the body part 310, the intake 320, the outlet 330, a detection part 340, an adsorption prevention part 350, and a spacer 360.

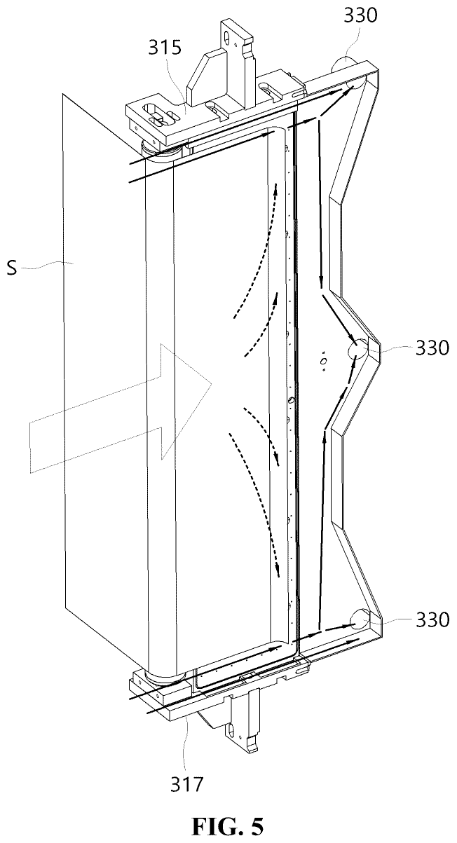

FIG. 5 is a reference view showing the internal space of a body part according to FIG. 2.

Referring to FIGS. 2 to 5, the body part 310 is configured to form the exterior surface or body of the tension adjustment part 30, and preferably has an internal space so that the side of a separator S located between the first roller 110 and the second roller 130 is inserted thereinside. The body part 310 may, for example, be of a plate-shaped configuration with an open side to the intake 320 and an internal space, but there is no particular limitation thereon. In addition, the detection part 340 and the adsorption prevention part 350 may be provided on opposing surfaces (first surface 311 and second surface 313) of the body part 310. In the drawing, the first surface 311 is shown as the top surface and the second surface 313 is shown as the bottom surface, but the scope of the present disclosure is not limited thereto.

As an example, the detection part 340 and the adsorption prevention part 350 may be provided on each of the first surface 311 and the second surface 313 of the body part 310. In the body part 310 on the side where the detection part 340 is provided, a through hole into which the individual detection part 340 is inserted may be formed to specify the position of the separator S on the internal space side of the body part 310.

For convenience of explanation, the through hole of the first surface 311 is referred to as a “first through hole 310a”, and the through hole of the second surface 313 is referred to as a “second through hole 310b” (see FIG. 4). As will be explained in detail below, when the detection part 340 is provided on both the first surface 311 and the second surface 313, and three sensors, a first limit sensor 341, a second limit sensor 343, and a home sensor 345, are provided on each of the surfaces 311 and 313, the first through hole 310a and the second through hole 310b may be spaced apart along the longitudinal direction and formed three times on individual surfaces 311 and 313. In addition, when the detection part 340 is provided with three sensors on only one surface 311 or 313, the second through hole 310b is not formed, and only three first through holes 310a may be formed on one side 311 or 313, spaced apart from each other along the longitudinal direction. It should be noted that the number of through holes formed in this way may be changed depending on the user's choice. The above term “longitudinal direction” may, for example, refer to the direction of separation between the intake 320 and the outlet 330.

In addition, an insertion hole may be formed on the side of the body part 310 where the adsorption prevention part 350 is formed, which directly communicates with the internal space of the individual adsorption prevention part 350 or allows the adsorption prevention part 350 to be inserted. For convenience of explanation, the insertion hole of the first surface 311 is referred to as a “first insertion hole 310c”, and the insertion hole of the second surface 313 is referred to as a “second insertion hole 310d” (see FIG. 4). The first insertion hole 310c allows the adsorption prevention part 350 coupled from the first surface 311 of the body part 310 to be inserted so that one adsorption prevention part 350 communicates with the internal space of the body part 310. The second insertion hole 310d allows the adsorption prevention part 350 coupled from the second surface 313 of the body part 310 to be inserted so that the other adsorption prevention part 350 communicates with the internal space of the body part 310. It should be noted that the number of insertion holes may also be changed depending on the user's choice. For example, one or more insertion holes may be formed on the first surface 311 or the second surface 313. That is, the number of insertion holes formed on each of the surfaces 311 and 311 may be changed depending on the number of adsorption prevention parts 350.

The intake 320 is configured to be open in the body part 310 on the side adjacent to the roller part 10 to allow one side of a separator S to be located in the internal space of the body part 310. That is, the intake 320 may allow the internal space of the body part 310 to communicate with the outside. In addition, as an example, when the air in the internal space of the body part 310 is sucked through the outlet 330, the intake 320 in communication with the outlet 330 may suck air outside the body part 310 into the internal space. At this time, one side of the separator S may move from the intake 320 toward the outlet 330 due to the pressure of the air flowing from the intake 320 to the outlet 330. That is, by pneumatic pressure applied to the side of the separator S located between the first roller 110 and the second roller 130, the separator S may be put into the internal space of the body part 310.

Accordingly, a predetermined tension may be applied to the separator S by pneumatic pressure generated through the outlet 330. Thus, even if there is a sudden change in the supply speed of a separator S, the tension applied to the separator S may be controlled by pneumatic pressure rather than mechanical control. As a result, the same problems as when applying the conventional dancer roll 910 do not occur.

The outlet 330 communicates with the internal space of the body part 310 and sucks air from the internal space of the body part 310. The outlet 330 is preferably formed, for example, at the end of the body part 310 on the side far from the intake 320. In addition, the outlet 330 may be provided as a single outlet on the body part 310 side, or a plurality of outlets 330 may be formed to be spaced apart from each other, but there is no particular limitation thereon. As an example, the outlet 330 may be formed on the first surface 311 or the second surface 313, and is preferably formed on the side adjacent to the edge of the body part 310 (see FIG. 5). The outlet 330 may be, for example, connected to a vacuum pump (not shown) so that a flow of air occurs from the intake 320 to the outlet 330 when the vacuum pump operates.

The detection part 340 is provided in the body part 310 and configured to detect the position of the separator S in the internal space of the body part 310. That is, since the internal space of the body part 310 is sealed except for the intake 320 and the outlet, it is not possible to know exactly where the separator S is located in the internal space of the body part 310. Thus, in an embodiment of the present disclosure, an objective is to specify the location of the separator S in the internal space of the body part 310 by means of the detection part 340. As previously described, the detection part 340 may be inserted into the through hole of the body part 310.

The detection part 340 may be any of known or to be known components, such as an ultrasonic sensor or a photosensor, but is preferably a photosensor, and is more preferably a transmission-type photosensor rather than a reflection-type photosensor for precise detection. In addition, the “detected location information” on the separator S obtained by the detection part 340 may be transmitted to the control part 50, which will be described later.

The detection part 340 may include the first limit sensor 341, the second limit sensor 343, and the home sensor 345. Below, it will be explained by way of example that the detection part 340 is composed of a transmission-type photosensor, and in this case, the individual sensors 341, 343, and 345 may be provided one each on the first surface 311 and the second surface 313 of the body part 310 to face each other. At this time, the sensors 341, 343, and 345 on the first surface 311 may be light emitting parts, whereas the sensors 341, 343, and 345 on the second surface 313 may be light receiving parts, and vice versa.

The first limit sensor 341 is provided on the side adjacent to the intake 320 and configured to detect the separator S in the internal space of the body part 310. As previously described, when the first limit sensor 341 is composed of a transmission-type photosensor, the first limit sensor 341 may be provided on the first surface 311 and on the second surface 313 of the body part 310.

The second limit sensor 343 is provided on the side adjacent to the outlet 330 and configured to detect the separator S in the internal space of the body part 310. The second limit sensor 343 may be provided between the first limit sensor 341 and the outlet 330. In addition, as previously described, when the second limit sensor 343 is composed of a transmission-type photosensor, the second limit sensor 343 may be provided on the first surface 311 and on the second surface 313 of the body part 310.

The home sensor 345 is provided between the first limit sensor 341 and the second limit sensor 343, and configured to detect the separator S in the internal space of the body part 310. As previously described, when the home sensor 345 is composed of a transmission-type photosensor, the home sensor 345 may be provided on the first surface 311 and on the second surface 313 of the body part 310. In addition, the individual home sensor 345 may be provided at any position between the adjacent first limit sensor 341 and the second limit sensor 343. For example, the individual home sensor 345 may be formed approximately at the center of the adjacent first limit sensor 341 and the second limit sensor 343, but there is no particular limitation thereon.

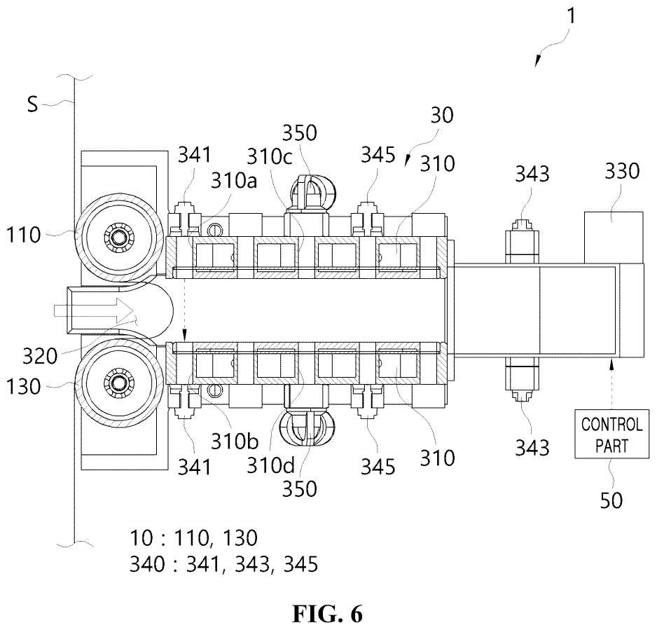

FIGS. 6 to 8 are reference vertical cross-sectional views showing the operation of a detection part and a control part.

Hereinafter, individual sensors 341, 343, and 345 and the function of the control part 50 using the sensors 341, 343, and 345 will be described in detail.

First, referring to FIG. 6, when the first limit sensor 341 does not detect a separator S located in the internal space of the body part 310, this means that the supply speed of the separator S to the stacking device 5 is faster than the reference speed. Accordingly, the control part 50 may momentarily stop the operation of the stacking device 5 or slow down the operation speed of the stacking device 5.

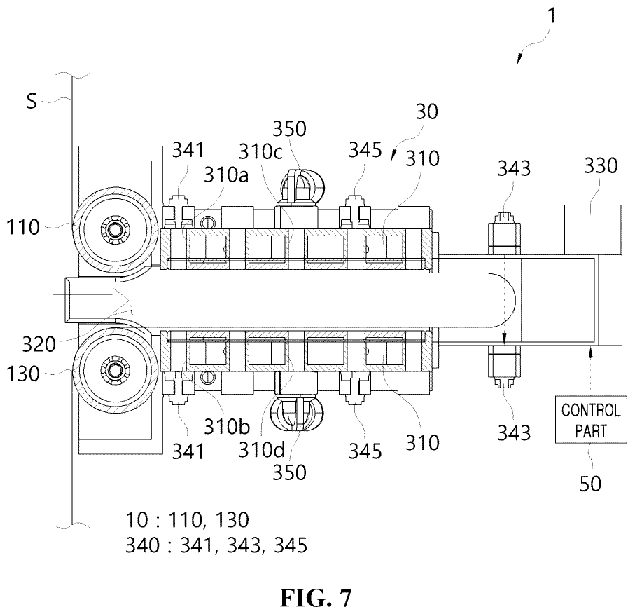

In addition, referring to FIG. 7, when the second limit sensor 343 detects a separator S located in the internal space of the body part 310, this means that the supply speed of the separator S through the feeding part 3 is faster than the reference speed compared to the processing speed of the stacking device 5. Accordingly, the control part 50 may stop the operation of the feeding part 3 or slow down the feeding speed. The above term “reference speed” is understood to mean target speed.

At the standby time of the stacking device 5, it is not clear exactly which sensor 341 or 343 a separator S is biased toward between the first limit sensor 341 and the second limit sensor 343. At this time, when the stacking device 5 is driven while a separator S is very close to the first limit sensor 341, if the separator S is not detected by the first limit sensor 341, the stacking device 5 may be stopped by the control part 50 as soon as it is driven. On the other hand, when the stacking device 5 is driven while a separator S is very close to the second limit sensor 343, if the separator S is detected by the second limit sensor 343, the operation of the feeding part 3 may be stopped as soon as the stacking device 5 is driven. The above term “standby time” is understood to mean the time before operation of the stacking device 5.

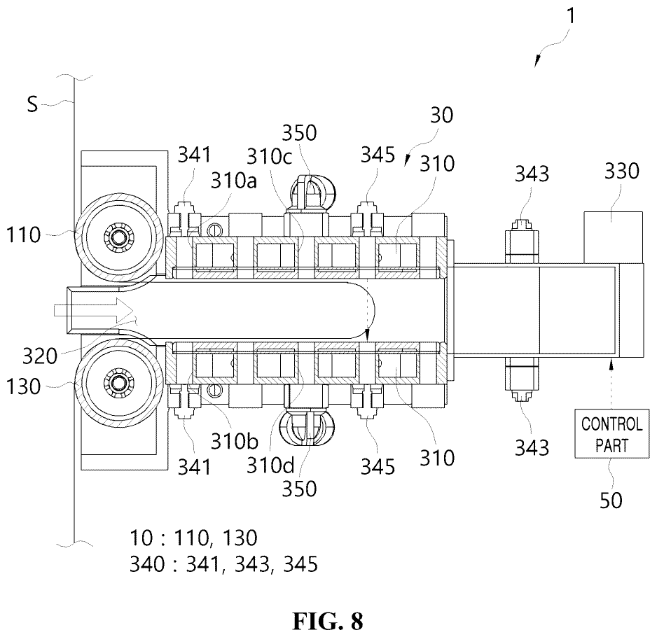

Referring to FIG. 8, in order to solve this problem, according to an embodiment of the present disclosure, at the standby time of the stacking device 5, the control part 50 stops the operation of the feeding part 3 as soon as a separator S is detected by the home sensor 345. Due to this, separators S may be supplied substantially to the home sensor 345 side. Afterwards, the control part 50 operates the feeding part 3 and the stacking device 5. As a result, the possibility of occurrence of the above-mentioned problems may be significantly reduced. In this way, the home sensor 345 may ensure that a separator S is inserted up to the reference position (position corresponding to the home sensor 345) at the standby time of the stacking device 5.

Referring to FIGS. 2 to 4, the adsorption prevention part 350 is configured to be coupled to the first surface 311 and/or the second surface 313 of the body part 310 to inject gas (e.g., air) into the internal space of the body part 310. For example, in the case of a separator S with a high viscosity, it may stick to the interior wall of the body part 310 after being introduced into the internal space of the body part 310. At this time, even if air is discharged through the outlet 330, the separator S may not move smoothly in the direction adjacent to the outlet 330 due to pneumatic pressure. The desired level of tension is not formed in the separator S. In order to solve this problem, according to an embodiment of the present disclosure, by injecting a gas such as air into the internal space of the body part 310 through the flow path of the adsorption prevention part 350 coupled through the first insertion hole 310c and/or the second insertion hole 310d, it is possible to prevent the exterior surface of the separator S from sticking to the interior wall of the body part 310.

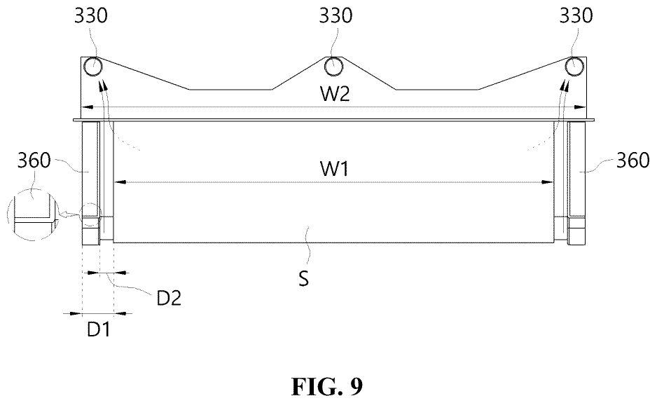

FIG. 9 is a reference view showing a spacer according to FIG. 2.

Referring to FIGS. 4 to 5, and 9, the spacer is provided on the side adjacent to a front surface 315 and/or a rear surface 317 of the body part 310 within the internal space of the body part 310 to control a flow path for air discharged toward the outlet 330. For example, in the internal space of the body part 310, a separator S is located between the front surface 315 and the rear surface 317 opposite the front surface 315. At this time, a front-to-back width size W1 of the separator S is formed to be smaller than a separation distance W2 between the front surface 315 and the rear surface 317. Accordingly, a gap (2D1=W2−W1) may be formed between the front surface 315 of the body part 310 and an adjacent end of the separator S, and between the rear surface 317 and an adjacent end of the separator S.

At this time, if the gap D1 is formed larger than necessary, the flow path of the air escaping toward the outlet 330 becomes too large, and thus the necessary level of pneumatic pressure may not be applied to the separator S. As a result, the tension applied to the separator S cannot be controlled to the desired level. On the other hand, if the gap D1 is formed smaller than necessary, the flow path of the air escaping toward the outlet 330 becomes too small and air is not discharged smoothly, and thus a traffic jam occurs, and damage such as folding of the edge of the separator S adjacent to the outlet 330 may occur.

In order to solve this problem, in the present disclosure, by forming the spacer 360 on the side adjacent to the front surface 315 and/or rear surface 317 of the body part 310 or on the interior wall of the front surface 315 and/or rear surface 317 within the internal space of the body part 310, an effective gap (D2; D1>D2) between the spacer 360 and the adjacent end of the separator S is controlled. That is, damage to the separator S may be prevented while maintaining the pressure applied to the separator S by the spacer 360 at a desired level. The spacer 360 may be, for example, coupled to the interior wall of the front surface 315 and/or rear surface 317 of the body part 310, or to the interior wall of the first surface 311 and/or second surface 313, and the scope of the present disclosure is not limited by specific examples.

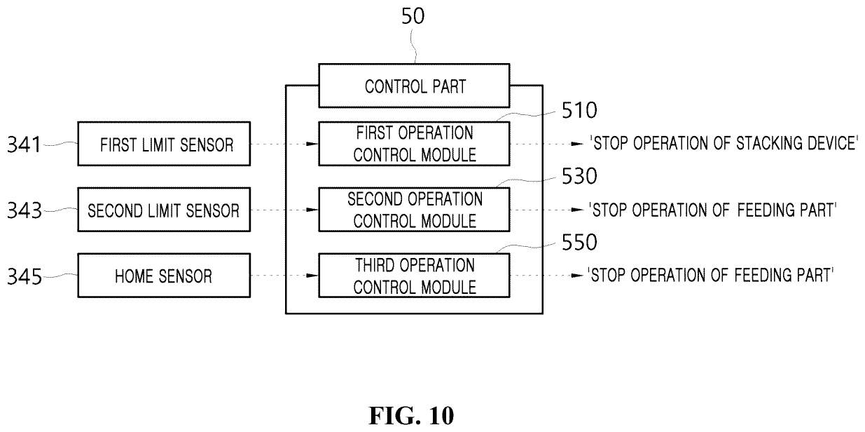

FIG. 10 is a block view of a control part according to FIG. 2.

Referring to FIGS. 2 and 10, the control part 50 is configured to control the operation of the apparatus 1 for supplying secondary battery separators, the feeding part 3, and the stacking device 5, and may receive location information detected by the detection part 340 as described above. For this purpose, the control part 50 may include a first operation control module 510, a second operation control module 530, and a third operation control module 550.

Referring to FIGS. 6 and 11, the first operation control module 510 stops the operation of the stacking device 5 or slows down the operation speed when the first limit sensor 341 does not detect the separator S located in the internal space of the body part 310. As previously described, when the first limit sensor 341 does not detect the separator S in the internal space of the body part 310, this means that the supply speed of separators S to the stacking device 5 is faster than the preset speed compared to the supply speed of separators S of the feeding part 3, and the first operation control module 510 may operate to correct this.

Referring to FIGS. 7 and 10, the second operation control module 530 stops the operation of the feeding part 3 or slows down the feeding speed when the second limit sensor 343 detects the separator S located in the internal space of the body part 310. As previously described, when the second limit sensor 343 detects the separator S in the internal space of the body part 310, this means that the supply speed of separators S through the feeding part 3 is faster than the preset speed compared to the processing speed of the stacking device 5, and the second operation control module 530 may operate to correct this.

Referring to FIGS. 8 and 10, the third operation control module 550 stops the operation of the feeding part 3 when the home sensor 345 detects the separator S at the standby time of the stacking device 5. Due to the third operation control module 550, the separator S may be placed in the reference position immediately before the stacking device 5 is driven.

The above detailed description is illustrative of the present disclosure. In addition, the above description shows and describes preferred embodiments of the present disclosure, and the present disclosure can be used in various other combinations, modifications, and environments. In other words, changes or modifications are possible within the scope of the concept of the disclosure disclosed herein, the scope equivalent to the written disclosure, and/or within the scope of skill or knowledge in the art. The above-described embodiment describes the best state for implementing the technical idea of the present disclosure, and various changes required in the specific application field and use of the present disclosure are possible. Accordingly, the detailed description of the present disclosure is not intended to limit the present disclosure to the disclosed embodiments.

### Description of Reference Numerals

1: apparatus for supplying separators
10: roller part
110: first roller 130: second roller
30: tension adjustment part
310: body part
310a: first through hole 310b: second through hole
310c: first insertion hole 310d: second insertion hole
311: first surface 313: second surface
315: front surface 317: rear surface
320: intake 330: outlet
340: detection part
341: first limit sensor 343: second limit sensor
345: home sensor
350: adsorption prevention part
50: control part
510: first operation control module 520: second operation control module
550: third operation control module
3: feeding part
5: stacking device
S: separator
W1: front-to-back width size of separator
W2: separation distance between front surface and rear surface of body part
D1: gap
D2: effective gap

1. An apparatus for supplying secondary battery separators, the apparatus comprising:
a pair of roller parts spaced apart from each other on a side adjacent to a tension adjustment part;
the tension adjustment part configured to control a tension applied to a separator put into an internal space thereof through pneumatic control; and
a control part configured to control an operation of the tension adjustment part.

2. The apparatus of claim 1, wherein the tension adjustment part comprises:
a body part constituting a body of the tension adjustment part and having the internal space for putting into a separator;
an intake configured to be formed open in the body part to allow a separator to be put into the internal space of the body part; and
an outlet configured to communicate with the internal space of the body part and allow air from the internal space of the body part to be sucked in and discharged.

3. The apparatus of claim 2, wherein the outlet is connected to a vacuum pump so that air flows from the intake and is discharged when the vacuum pump operates.

4. The apparatus of claim 2, wherein the tension adjustment part further comprises:
a detection part disposed on a side of the body part to detect a position of a separator put into the internal space of the body part.

5. The apparatus of claim 4, wherein the detection part comprises:
a first limit sensor provided on a side adjacent to the intake and configured to detect a separator in the internal space of the body part; and
a second limit sensor spaced apart from the first limit sensor on a side adjacent to the outlet and configured to detect a separator in the internal space of the body part.

6. The apparatus of claim 5, wherein the detection part further comprises:
a home sensor provided between the first limit sensor and the second limit sensor and configured to detect a separator in the internal space of the body part.

7. The apparatus of claim 6, wherein the home sensor is located at a random position between the adjacent first and second limit sensors.

8. The apparatus of claim 6, wherein the detection part is composed of a photosensor.

9. The apparatus of claim 2, wherein the tension adjustment part further comprises:
an adsorption prevention part coupled to first and/or second surfaces of the body part and configured to inject gas into the internal space of the body part.

10. The apparatus of claim 2, wherein the tension adjustment part further comprises:
a spacer provided on a side of front and/or rear surfaces or on a side adjacent to the front and/or rear surfaces of the body part in the internal space of the body part, and configured to set a size of a gap between an interior wall of the front and/or rear surfaces of the body part and an adjacent separator end.

11. The apparatus of claim 5, further comprising:
a feeding part configured to supply separators to the tension adjustment part; and
a stacking device configured to perform a stacking operation using separators supplied from the roller parts and the tension adjustment part, and
the control part comprises:
a first operation control module configured to stop an operation of the stacking device or slow down an operation speed when the first limit sensor does not detect a separator located in the internal space of the body part.

12. The apparatus of claim 11, wherein the control part further comprises:
a second operation control module configured to stop an operation of the feeding part or slow down a feeding speed when the second limit sensor detects a separator located in the internal space of the body part.

13. The apparatus of claim 6, further comprising:
a feeding part configured to supply separators to the tension adjustment part; and
a stacking device configured to perform a stacking operation using separators supplied from the roller parts and the tension adjustment part, and
the control part further comprises:
a third operation control module configured to stop an operation of the feeding part when the home sensor detects a separator at a standby time of the stacking device.
